(19) United States
(12) Patent Application Publication
(10) Pub. No.: US 2012/0136691 A1
(43) Pub. Date: May 31, 2012

(54) SYSTEM AND METHOD FOR MANAGING POSTAL DELIVERY OPERATION LOAD

(75) Inventor: Jeong Hyun PARK, Daejeon (KR)

(73) Assignee: Electronics and Telecommunications Research Institute, Daejon (KR)

(21) Appl. No.: 13/303,498

(22) Filed: Nov. 23, 2011

(30) Foreign Application Priority Data
Nov. 26, 2010 (KR) 10-2010-0118690

(51) Int. Cl. G06Q 10/06

(52) U.S. Cl. 705/7.22; 705/7.27

(57) ABSTRACT

Disclosed herein is a system and method for objectively and efficiently managing a postal delivery operation load. A system for managing a postal delivery operation load includes: a postal delivery operation load calculator for calculating a postal delivery operation load for each postal delivery unit and for each period based on input postal delivery data; a postal delivery operation load calculation result manager for managing the postal delivery operation load for each postal delivery unit based on the postal delivery operation load calculation result provided by the postal delivery operation load calculator; and a postal delivery operation load adjuster for adjusting and leveling the postal delivery operation based on postal delivery operation load management information provided by the postal delivery operation load calculation result manager.

### CROSS-REFERENCE TO RELATED PATENT APPLICATION

This application claims the benefit of Korean Patent Application No. 10-2010-0118690, filed on Nov. 26, 2010, in the Korean Intellectual Property Office, the disclosure of which is incorporated herein in its entirety by reference.

### BACKGROUND OF THE INVENTION

1. Field of the Invention

The present invention relates to a postal delivery operation load management and, more particularly, to a system and method for objectively and efficiently managing a postal delivery operation load.

2. Description of the Related Art

With the development of communication systems and IT industry, home shopping, online shopping, etc. are activated, and thus the amount of regular mail such as letters has been greatly reduced and the amount of registered mail, parcels, and courier mail have been rapidly increased.

In these changes, a post office that provides a postal delivery service is asked to provide additional services as well as the postal delivery service. Therefore, the postman's visit to each home becomes more frequent to pick up parcels instead of letters, and thus the change in postal delivery operation environment due to limited human resources increases work strength of postmen.

Moreover, typically, the collected mail is classified with respect to about 25 postal central offices and then transported to each postal central office. The postal central office distributes and transports the mail to about 500 nationwide distributing post offices. In most of the distributing post offices, the postmen sort the mail manually one by one. Therefore, though the mail is sorted without delay in the postal central office, when much of the mail is received, the workload exceeds the capacity of the postmen. Also, due to the change in postal delivery operation environment such as a continuous increase in the number of new delivery locations, an increase in the amount of mail returned due to an increase in the number of recipient households absent in the daytime, and a rapid increase in the amount of postal couriers, the postman's delivery workload is increasing.

Due to the aforementioned increase in the postal delivery operation load, various methods for systematically managing the postal delivery operation load have been proposed.

In a conventional method for calculating and managing a postal delivery operation load, the postal delivery operation load is calculated by grading and classifying nationwide distributing post offices into various types based on the calculation of human resources required for the postal delivery operation and by adding a reference value to each type or by classifying the distributing post offices into urban type-A, urban type-B, urban-rural type-A, urban-rural type-B, rural type-A, rural type-B, etc., for example, in terms of population and city size and by adding a reference value to each of the classified six types.

However, according to the conventional method, the criterion for each type of the distributing post offices classified is not accurate, and further, when the postal delivery operation load is calculated by applying a reference value to each classified type, the calculated postal delivery operation load is quite different from the real environment and is not suitable for being used as a practical model for calculating and managing the postal delivery operation load.

### SUMMARY OF THE INVENTION

The present invention has been made in an effort to solve the above-described problems associated with prior art, and an object of the present invention is to provide a system for managing a postal delivery operation load, which can objectively and substantially calculate and manage the postal delivery operation load and further efficiently manage human resources required for postal delivery operation.

Another object of the present invention is to provide a method for managing a postal delivery operation load, which can objectively and substantially calculate and manage the postal delivery operation load and further efficiently manage human resources required for postal delivery operation.

According to an aspect of the present invention to achieve the above object of the present invention, there is provided a system for managing a postal delivery operation load, the system comprising: a postal delivery operation load calculator for calculating a postal delivery operation load for each postal delivery unit and for each period based on input postal delivery data; a postal delivery operation load calculation result manager for managing the postal delivery operation load for each postal delivery unit based on the postal delivery operation load calculation result provided by the postal delivery operation load calculator; and a postal delivery operation load adjuster for adjusting and leveling the postal delivery operation based on postal delivery operation load management information provided by the postal delivery operation load calculation result manager.

The postal delivery operation load calculator may calculate a daily postal delivery operation load for each postman based on at least one of a daily mail sorting time, a moving time, a delivery time, and an additional working time for each postman and calculate at least one of weekly, monthly, quarterly, and annual postal delivery operation loads for each postman based on the calculated daily postal delivery operation load for each postman.

The postal delivery operation load calculator may calculate a daily postal delivery operation load for each postal delivery team based on the calculated daily postal delivery operation load for each postman and calculate at least one of weekly, monthly, quarterly, and annual postal delivery operation loads for each postal delivery team based on the calculated daily postal delivery operation load for each postal delivery team.

The postal delivery operation load calculator may calculate a daily postal delivery operation load for each distributing post office based on the calculated daily postal delivery operation load for each postal delivery team and calculate at least one of weekly, monthly, quarterly, and annual postal delivery operation loads for each distributing post office based on the calculated daily postal delivery operation load for each distributing post office.

The postal delivery operation load calculator may calculate a postal delivery operation value by summing all the daily mail sorting time, the moving time, the delivery time, and the additional working time for each postman, calculate a total postal delivery operation by adding a predetermined margin value to the calculated postal delivery operation value, and then calculate the daily postal delivery operation load for each postman by dividing the total postal delivery operation by a daily standard working time.

The mail sorting time may be calculated based on the amount of mail and a standard processing time per mail for each mail type and for each delivery condition, the moving time may be calculated based on a moving distance and a standard moving time per kilometer for each delivery condition, the delivery time may be calculated based on the amount of mail and a standard processing time per mail for each mail type and for each delivery condition, the number of delivery locations for each mail type and for each delivery condition, and a standard processing time per delivery location, and the additional working time may be calculated based on the amount of mail returned and collected, a standard processing time per mail, and a time for a fixed work.

The system for managing the postal delivery operation load may further comprise: a data linker for collecting information on the amount of mail to be delivered, which is distributed and delivered to each distributing post office by a postal central office; a data inputter for receiving data input for the purpose of calculating the postal delivery operation load or data relating to the postal delivery operation input through a postal management terminal; and an input data verifier for verifying the accuracy of the data provided from the data linker and the data inputter and providing the verified data to the postal delivery operation load calculator.

The system for managing the postal delivery operation load may further comprise: a postal delivery operation load parameter adjuster for adjusting postal delivery operation load calculation factors or models and providing the adjusted results to the postal delivery operation load calculator; a postal delivery operation load calculation result verifier for statistically analyzing and verifying the postal delivery operation load calculation result calculated for each postal delivery unit and for each period and provided by the postal delivery operation load calculator; a postal delivery database for storing data required for the postal delivery operation; and a postal delivery database linker for linking the postal delivery database to the postal delivery operation load calculator for the purpose of calculating the postal delivery operation load.

The system for managing the postal delivery operation load may further comprise: a postal delivery operation result manager for analyzing and managing a postal delivery operation result based on the postal delivery operation load calculation result provided by the postal delivery operation load calculator and a postal delivery operation load adjustment result provided by the postal delivery operation load adjuster; and a postal delivery operation load monitor for monitoring, in real time, the calculated postal delivery operation load.

According to another aspect of the present invention to achieve the above object of the present invention, there is provided a method for managing a postal delivery operation load, the method comprising the steps of: obtaining data for calculating a postal delivery operation load; calculating factors for calculating the postal delivery operation load based on the obtained data for calculating the postal delivery operation load; and calculating the postal delivery operation load based on the factors for calculating the postal delivery operation load.

The step of obtaining the data for calculating the postal delivery operation load may comprise obtaining at least one of information on the amount of mail returned and collected, information on a time for a fixed work, information on a moving distance for each delivery condition, information on the amount of mail for each mail type and for each delivery condition, and information on the number of delivery locations for each mail type and for each delivery condition.

The step of calculating the factors for calculating the postal delivery operation load may comprise: calculating an additional working time based on the amount of mail returned and collected, a standard processing time per mail, and a time for a fixed work; calculating a moving time based on a moving distance and a standard moving time per kilometer for each delivery condition; calculating a mail sorting time based on the amount of mail and a mail sorting time per mail for each mail type and for each delivery condition; and calculating a delivery time based on the amount of mail and a mail sorting time per mail for each mail type and for each delivery condition, the number of delivery locations for each mail type and for each delivery condition, and a standard processing time per delivery location.

The step of calculating the postal delivery operation load may further comprise: calculating a postal delivery operation value by summing all the mail sorting time, the moving time, the delivery time, and the additional working time, calculating a total postal delivery operation by adding a predetermined margin value to the calculated postal delivery operation value, and then calculating a daily postal delivery operation load for each postman by dividing the total postal delivery operation by a daily standard working time; and calculating at least one of weekly, monthly, quarterly, and annual postal delivery operation loads for each postman based on the calculated daily postal delivery operation load for each postman.

The step of calculating the postal delivery operation load may further comprise: calculating a daily postal delivery operation load for each postal delivery team based on the calculated daily postal delivery operation load for each postman; calculating at least one of weekly, monthly, quarterly, and annual postal delivery operation loads for each postal delivery team based on the calculated daily postal delivery operation load for each postal delivery team.

The step of calculating the postal delivery operation load may further comprise: calculating a daily postal delivery operation load for each distributing post office based on the calculated daily postal delivery operation load for each postal delivery team; and calculating at least one of weekly, monthly, quarterly, and annual postal delivery operation loads for each distributing post office based on the calculated daily postal delivery operation load for each distributing post office.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing the configuration of a postal delivery operation load management system in accordance with an exemplary embodiment of the present invention;

FIG. 2 shows factors for calculating a postal delivery operation load and a method therefor in accordance with an exemplary embodiment of the present invention;

FIG. 3 is a flowchart showing a method for calculating a postal delivery operation load in accordance with an exemplary embodiment of the present invention;

FIG. 4 shows a display screen for calculating a postal delivery operation load provided by the postal delivery operation load management system in accordance with an exemplary embodiment of the present invention;

FIG. 5 shows a display screen for displaying a postal delivery operation overload provided by the postal delivery operation load management system in accordance with an exemplary embodiment of the present invention;

FIG. 6 shows a graph display screen for displaying a postal delivery operation load provided by the postal delivery operation load management system in accordance with an exemplary embodiment of the present invention;

FIG. 7 shows a graph display screen for displaying detailed components of the postal delivery operation load provided by the postal delivery operation load management system in accordance with an exemplary embodiment of the present invention;

FIG. 8 shows a display screen for verifying postal delivery operation performance history and input data provided by the postal delivery operation load management system in accordance with an exemplary embodiment of the present invention; and

FIG. 9 shows a display screen for displaying a postal delivery operation result provided by the postal delivery operation load management system in accordance with an exemplary embodiment of the present invention.

### DETAILED DESCRIPTION OF THE INVENTION

While the invention is susceptible to various modifications and alternative forms, specific embodiments thereof are shown by way of example in the drawings and will herein be described in detail.

It should be understood, however, that there is no intent to limit the invention to the particular forms disclosed, but on the contrary, the invention is to cover all modifications, equivalents, and alternatives falling within the spirit and scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments in accordance with the present invention will be described with reference to the accompanying drawings. The exemplary embodiments are provided so that those skilled in the art can sufficiently understand the present invention, but can be modified in various forms and the scope of the present invention is not limited to the exemplary embodiments. Like reference numerals in the drawings denote like elements, and thus repeated descriptions will be omitted.

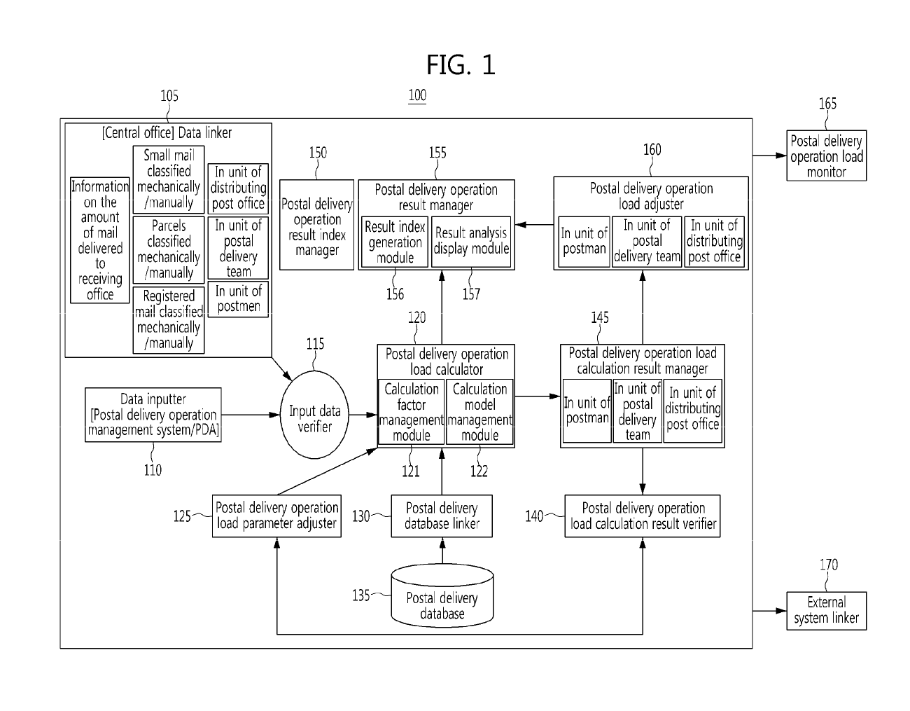

FIG. 1 is a block diagram showing the configuration of a postal delivery operation load management system in accordance with an exemplary embodiment of the present invention.

Referring to FIG. 1, a postal delivery operation load management system 100 may include a data linker 105, a data inputter 110, an input data verifier 115, a postal delivery operation load calculator 120, a postal delivery operation load parameter adjuster 125, a postal delivery database linker 130, a postal delivery database 135, a postal delivery operation load calculation result verifier 140, a postal delivery operation load calculation result manager 145, a postal delivery operation result index manager 150, a postal delivery operation result manager 155, a postal delivery operation load adjuster 160, a postal delivery operation load monitor 165, and an external system linker 170.

The data linker 105 collects information on the amount of mail to be delivered, which is distributed and delivered to each distributing post office by a postal central office, and provides the information to the input data verifier 115. Here, the data linker 105 may collect information on the amount of mail to be delivered to a receiving office and information on the amount of small mail, parcels, or registered mail which are mechanically or manually classified and may collect the information on the amount of mail to be delivered in units of distributing post offices, in units of postal delivery teams, or in units of postmen.

The data inputter 110 receives data relating to the postal delivery operation, which is directly input by a postman or through a postal management terminal such as PDA and the like for the purpose of calculating the postal delivery operation load and provides the data to the input data verifier 115.

The input data verifier 115 verifies the accuracy of the data provided from the data linker 105 and the data inputter 110 and provides the verified data to the postal delivery operation load calculator 120.

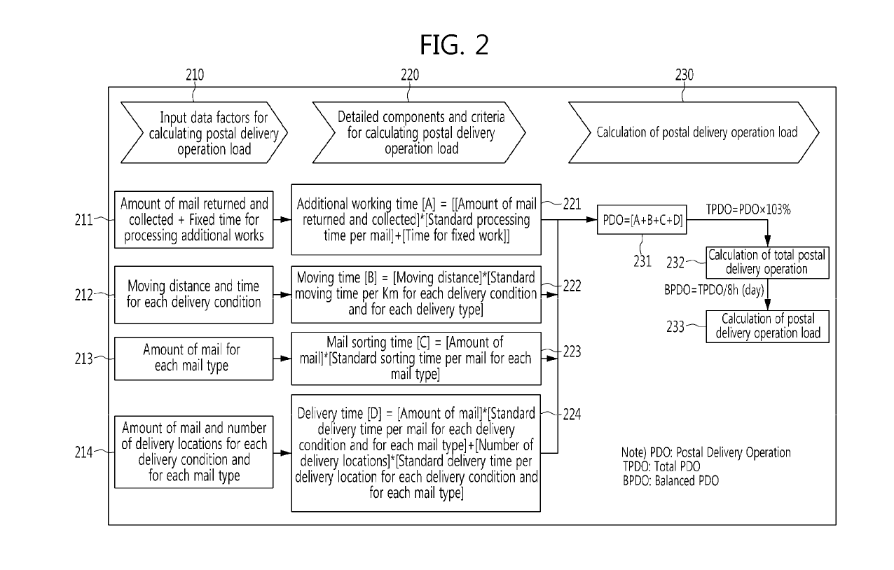

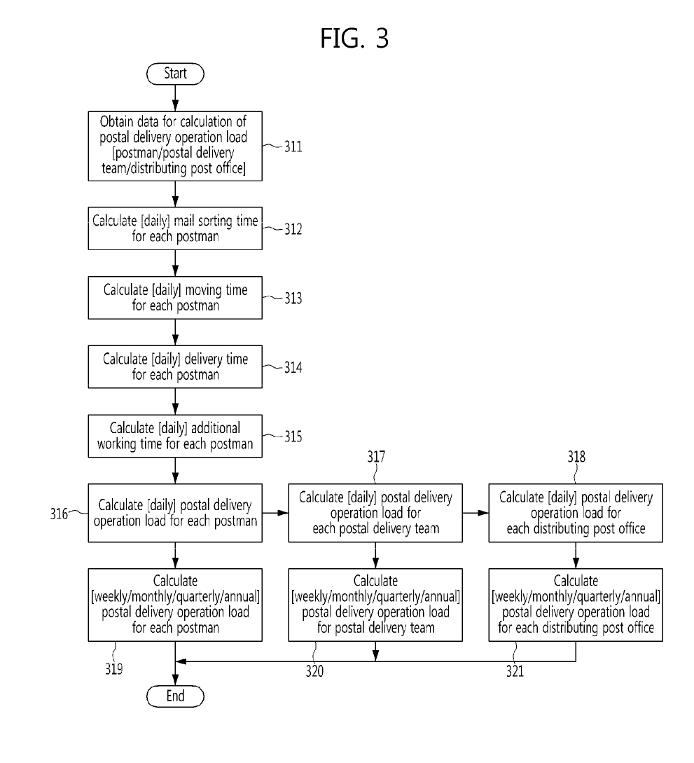

The postal delivery operation load calculator 120 calculates, as will be described below in FIGS. 2 and 3, a postal delivery operation load for each postman, for each postal delivery team, and for each distributing post office based on the data provided from the input data verifier 115 and calculates a postal delivery operation load for each period or for each date.

The postal delivery operation load calculator 120 may include a calculation factor management module 121 and a calculation model management module 122. The calculation factor management module 121 manages factors required to calculate the postal delivery operation load. The calculation model management module 122 manages models for calculating the postal delivery operation load.

The postal delivery operation load parameter adjuster 125 adjusts the postal delivery operation load calculation factors and models and provides the adjusted results to the postal delivery operation load calculator 120.

The postal delivery database linker 130 links the postal delivery database 135 to the postal delivery operation load calculator 120 for the purpose of calculating the postal delivery operation load.

The postal delivery database 135 includes data required for the postal delivery operation such as addresses of delivery locations, etc.

The postal delivery operation load calculation result verifier 140 statistically analyzes and verifies the postal delivery operation load calculation result calculated for each postman, for each postal delivery team, and for each distributing post office and/or for each period or for each date.

The postal delivery operation load calculation result manager 145 manages the postal delivery operation load calculation results provided by the postal delivery operation load calculator 120. Here, the postal delivery operation load calculation result manager 145 can manage the postal delivery operation load for each postman, for each postal delivery team, and for each distributing post office.

The postal delivery operation result index manager 150 adjusts and processes postal delivery operation result indexes.

The postal delivery operation result manager 155 analyzes and manages the postal delivery operation result based on the postal delivery operation load calculation result provided by the postal delivery operation load calculator 120 and the postal delivery operation load adjustment result provided by the postal delivery operation load adjuster 160. Here, the postal delivery operation result manager 155 may include a result index generation module 156 and a result analysis display module 157. The result index generation module 156 generates and manages indexes of the postal delivery operation results. The result analysis display module 157 analyzes and displays the postal delivery operation results.

The postal delivery operation load adjuster 160 adjusts or levels the postal delivery operation based on the postal delivery operation load management information provided by the postal delivery operation load calculation result manager 145.

The postal delivery operation load monitor 165 monitors, in real time, the postal delivery operation load calculated for each postman, for each postal delivery team, and for each distributing post office and/or for each period or for each date.

The external system linker 170 links to an external system for the purpose of managing the postal delivery operation load and the postal delivery operation result.

FIG. 2 shows a process of calculating a postal delivery operation load in accordance with an exemplary embodiment of the present invention.

Referring to FIG. 2, the process of calculating a postal delivery operation load in accordance with an exemplary embodiment of the present invention may generally include a process of selecting input data factors 210 for the calculation of the postal delivery operation load, a process of selecting detailed components and criteria 220 for the calculation of the postal delivery operation load, and a process of calculating the postal delivery operation load 230.

The input data factors 210 for the calculation of the postal delivery operation load may include the amount of mail returned and collected and an additional working time 211, a moving distance and time 212 for each delivery condition, the amount of mail 213 for each mail type and for each delivery condition, and the number of delivery locations 214 for each delivery condition and for each mail type.

The detailed components and criteria 220 for the calculation of the postal delivery operation load 220 may include an additional working time [A] 221, a moving time [B] 222, a mail sorting time [C] 223, and a delivery time [D] 224. The additional working time [A] 221 is calculated based on the amount of mail returned and collected, a standard processing time per mail, and a time for a fixed work. The moving time [B] 222 is calculated based on a moving distance and a standard moving time per kilometer for each delivery condition. The mail sorting time [C] 223 is calculated based on the amount of mail and a standard sorting time per mail for each mail type and for each delivery condition. The delivery time [D] 224 is calculated based on a statistical standard delivery time for each delivery condition and for each mail type, the amount of mail delivered, and the number of delivery locations.

The process of calculating the postal delivery operation load 230 calculates a postal delivery operation (PDO) value by summing all the additional working time [A], the moving time [B], the mail sorting time [C], and the delivery time [D] (see reference numeral 231), adds a margin value (for example, 3%) to the postal delivery operation (PDO) value, and then calculates a total postal delivery operation (TPDO) (see reference numeral 232). Then, a postal delivery operation load (balanced PDO (BPDO)) is finally calculated by dividing the TPDO by 8 hours, a daily standard working time (see reference numeral 233).

FIG. 3 is a flowchart showing a method for calculating a postal delivery operation load in accordance with an exemplary embodiment of the present invention, in which the postal delivery operation load is calculated for each nationwide communication office, for each distributing post office, for each postal delivery team, and for each postman and/or for each period and for each date. The process of calculating the postal delivery operation load shown in FIG. 3 can be performed by the postal delivery operation load calculator 120 shown in FIG. 1.

Referring to FIG. 3, first, the postal delivery operation load management system obtains data for the calculation of the postal delivery operation load (step 311). Here, the data for the calculation of the postal delivery operation load may include information on the amount of mail for each mail type and for each delivery condition, information on the number of delivery locations for each mail type and for each delivery condition, and information on the moving distance for each delivery condition, etc.

Then, the postal delivery operation load management system calculates a daily mail sorting time for each postman (step 312) and calculates a daily moving time for each postman (step 313).

Moreover, the postal delivery operation load management system calculates a daily delivery time for each postman (step 314) and calculates a daily additional working time for each postman (step 315).

Then, the postal delivery operation load management system calculates a daily postal delivery operation load for each postman (step 316) based on the daily mail sorting time, the daily moving time, the daily delivery time, and the daily additional working time for each postman, all of which are calculated by the above process. Here, the amount of daily postal delivery operation load for each postman can be calculated by the process described above with reference to FIG. 2 (230 of FIG. 2).

Subsequently, the postal delivery operation load management system calculates the amount of daily postal delivery operation load for each postal delivery team to which a postman belongs (step 317) based on the calculated amount of daily postal delivery operation load for each postman, and calculates the amount of daily postal delivery operation load for each distributing post office (step 318) based on the calculated amount of daily postal delivery operation load for each postal delivery team.

Next, the postal delivery operation load management system calculates weekly, monthly, quarterly, and annual amounts of postal delivery operation load for each postman (step 319) based on the amount of daily postal delivery operation load for each postman, which has been calculated through step 316, and calculates weekly, monthly, quarterly, and annual amounts of postal delivery operation load for each postal delivery team (step 320) based on the amount of daily postal delivery operation load for each postal delivery team, which has been calculated through step 317. Moreover, the postal delivery operation load management system calculates weekly, monthly, quarterly, and annual amounts of postal delivery operation load for each distributing post office (step 321) based on the amount of daily postal delivery operation load for each distributing post office, which has been calculated through step 318.

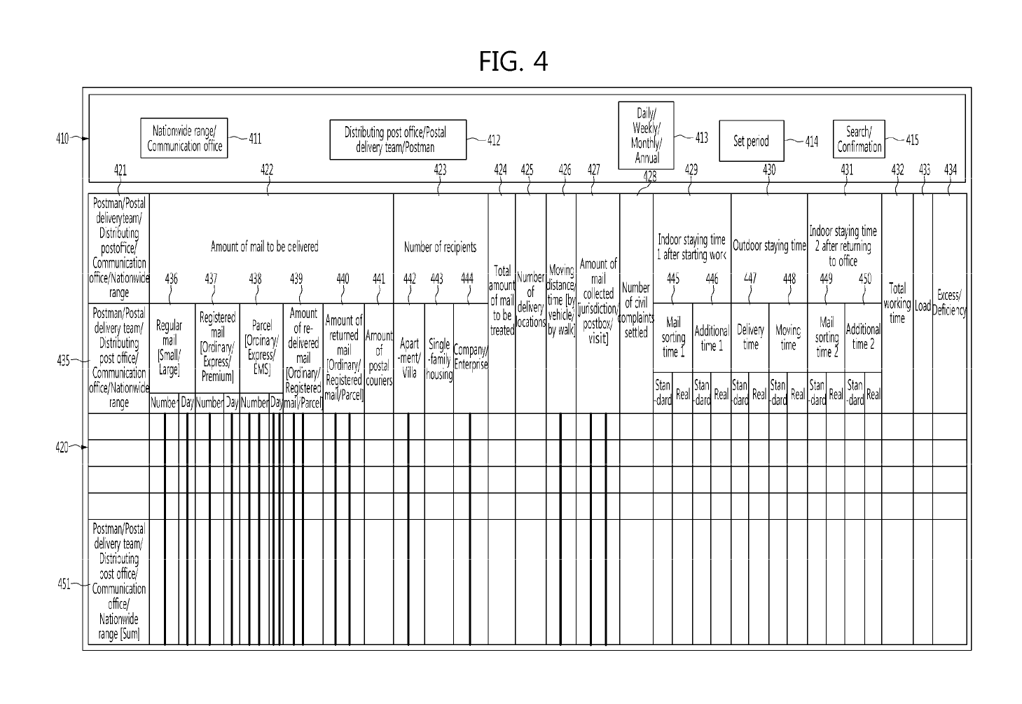

FIG. 4 shows a display screen for calculating a postal delivery operation load provided by the postal delivery operation load management system in accordance with an exemplary embodiment of the present invention.

Referring to FIG. 4, the display screen for the calculation of the postal delivery operation load generally includes a display item selection area 410 and a selected information display area 420. The display item selection area 410 allows a user to select one of a nationwide range, a communication office, a distributing post office, a postal delivery team, and a postman or to select a date with respect to the calculated postal delivery operation load. The selected information display area 420 shows the postal delivery operation load with respect to the selected item.

The display item selection area 410 may comprise a section 411 for selecting the nationwide range or the communication office, a section 412 for selecting one of the distributing post office, the postal delivery team, and the postman, a section 413 for selecting one of the daily, weekly, monthly, and annual amounts of postal delivery operation load, a section 414 for setting a period, and a section 415 for search and confirmation.

The selected information display area 420 may include a section 421 for selecting one of the postman, the postal delivery team, the distributing post office, the communication office, and the nationwide range, a section 422 for displaying the amount of mail to be delivered, a section 423 for displaying the number of recipients, a section 424 for displaying the total amount of mail to be treated, a section 425 for displaying the number of delivery locations, a section 426 for displaying a vehicle travel distance and a walking distance, a section 427 for displaying the amount of mail collected from postboxes and the amount of mail picked up, a section 428 for displaying the number of civil complaints settled, a section 429 for displaying an indoor staying time after starting work, a section 430 for displaying an outdoor staying time, a section 431 for displaying an indoor staying time after returning to the office, a section 432 for displaying a total working time, a section 433 for displaying the postal delivery operation load, a section 434 for displaying excess and deficiency, a section 435 for displaying an item selected from the postman, the postal delivery team, the distributing post office, the communication office, and the nationwide range, and a section 451 for displaying a total sum of postal delivery operation loads of the items selected from the postman, the postal delivery team, the distributing post office, the communication office, and the nationwide range.

The section 422 for displaying the amount of mail delivered may include a section 436 for displaying the amount of large and small regular mail, a section 437 for displaying the amount of registered mail such as registered mail, express mail, contract registered mail, etc., a section 438 for displaying the amount of parcels such as parcels, express parcels, international express mail (EMS), etc., a section 439 for displaying the amount of re-delivered regular mail, registered mail, and parcels, a section 440 for displaying the amount of returned regular mail, registered mail, and parcels, and a section 441 for displaying the amount of postal couriers.

The section 423 for displaying the number of recipients may include a section 442 for displaying the number of recipients such as apartments, multi-family housing, villas, condominiums, complex buildings etc., a section 443 for displaying the number of recipients such as single-family housing, private businesses, etc. and a section 444 for displaying the number of recipients such as schools, hospitals, public institutions, companies or incorporated entities.

The section 429 for displaying the indoor staying time after starting work may include a section 445 for displaying a mail sorting time for separating and combining the mail routes with respect to registered mail or parcels to be delivered on a day, a section for displaying an actual elapsed time and a statistical reference value for the mail sorting time, a section 446 for displaying an additional time required to use a system for processing the postal delivery operation to be performed and registering the amount of mail to be delivered before departing from the office, and a section for displaying an actual elapsed time and a statistical reference value for the additional time.

The section 430 for displaying the outdoor staying time after departing from the office may include a section 447 for displaying an elapsed time for the mail delivery on a day, a section for displaying an actual elapsed time and a statistical reference value for the elapsed time, a section 448 for displaying a moving time for the mail delivery, and a section for displaying an actual elapsed time and a statistical reference value for the moving time.

The section 431 for displaying the indoor staying time after returning to the office may include a section 449 for displaying a mail sorting time for separating and combining the mail routes with respect to regular mail to be delivered on the next day, a section for displaying an actual elapsed time and a statistical reference value for the mail sorting time, a section 450 for displaying an additional time required to use a system for processing the postal delivery operation performed and registering the amount of mail delivered after returning to the office, and a section for displaying an actual elapsed time and a statistical reference value for the additional time.

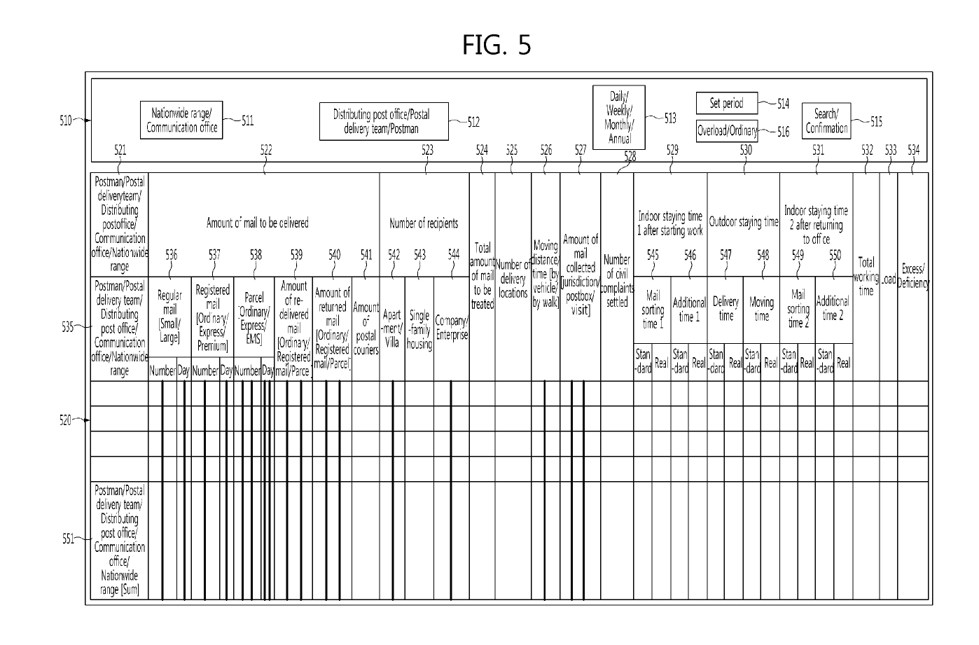

FIG. 5 shows a display screen for displaying a postal delivery operation overload provided by the postal delivery operation load management system in accordance with an exemplary embodiment of the present invention.

Referring to FIG. 5, the display screen for displaying the postal delivery operation overload includes a display item selection area 510 and a selected information display area 520. The display item selection area 510 allows a user to select one of the nationwide range, the communication office, the distributing post office, the postal delivery team, and the postman or to select a date with respect to the calculated postal delivery operation overload. The selected information display area 520 shows the postal delivery operation overload and average with respect to the selected item.

The display item selection area 510 may include a section 511 for selecting the nationwide range or the communication office, a section 512 for selecting one of the distributing post office, the postal delivery team, and the postman, a section 513 for selecting one of the daily, weekly, monthly, and annual amounts of the postal delivery operation load, a section 514 for setting a period, a section 515 for search and confirmation, and a section 516 for selecting the postal delivery operation overload and a general (average) postal delivery operation load.

The selected information display area 520 may include a section 521 for selecting one of the postman, the postal delivery team, the distributing post office, the communication office, and the nationwide range, a section 522 for displaying the amount of mail to be delivered, a section 523 for displaying the number of recipients, a section 524 for displaying the total amount of mail to be treated, a section 525 for displaying the number of delivery locations, a section 526 for displaying a vehicle travel distance and a walking distance, a section 527 for displaying the amount of mail collected from postboxes and the amount of mail picked up, a section 528 for displaying the number of civil complaints settled, a section 529 for displaying an indoor staying time after starting work, a section 530 for displaying an outdoor staying time, a section 531 for displaying an indoor staying time after returning to the office, a section 532 for displaying a total working time, a section 533 for displaying the postal delivery operation load, a section 534 for displaying excess and deficiency, a section 535 for displaying an item selected from the postman, the postal delivery team, the distributing post office, the communication office, and the nationwide range, and a section 551 for displaying a total sum of postal delivery operation loads of the items selected from the postman, the postal delivery team, the distributing post office, the communication office, and the nationwide range.

The section 522 for displaying the amount of mail delivered may include a section 536 for displaying the amount of large and small regular mail, a section 537 for displaying the amount of registered mail such as registered mail, express mail, contract registered mail, etc., a section 538 for displaying the amount of parcels such as parcels, express parcels, international express mail (EMS), etc., a section 539 for displaying the amount of re-delivered regular mail, registered mail, and parcels, a section 540 for displaying the amount of returned regular mail, registered mail, and parcels, and a section 541 for displaying the amount of postal couriers.

The section 523 for displaying the number of recipients may include a section 542 for displaying the number of recipients such as apartments, multi-family housing, villas, condominiums, complex buildings etc., a section 543 for displaying the number of recipients such as single-family housing, private businesses, etc. and a section 544 for displaying the number of recipients such as schools, hospitals, public institutions, companies or incorporated entities.

The section 529 for displaying the indoor staying time after starting work may include a section 545 for displaying a mail sorting time for separating and combining the mail routes with respect to registered mail or parcels to be delivered on a day, a section for displaying an actual elapsed time and a statistical reference value for the mail sorting time, a section 546 for displaying an additional time required to use a system for processing the postal delivery operation to be performed and registering the amount of mail to be delivered before departing from the office, and a section for displaying an actual elapsed time and a statistical reference value for the additional time.

The section 530 for displaying the outdoor staying time after departing from the office may include a section 547 for displaying an elapsed time for the mail delivery on a day, a section for displaying an actual elapsed time and a statistical reference value for the elapsed time, a section 548 for displaying a moving time for the mail delivery, and a section for displaying an actual elapsed time and a statistical reference value for the moving time.

The section 531 for displaying the indoor staying time after returning to the office may include a section 549 for displaying a mail sorting time for separating and combining the mail routes with respect to regular mail to be delivered on the next day, a section for displaying an actual elapsed time and a statistical reference value for the mail sorting time, a section 550 for displaying an additional time required to use a system for processing the postal delivery operation performed and registering the amount of mail delivered after returning to the office, and a section for displaying an actual elapsed time and a statistical reference value for the additional time.

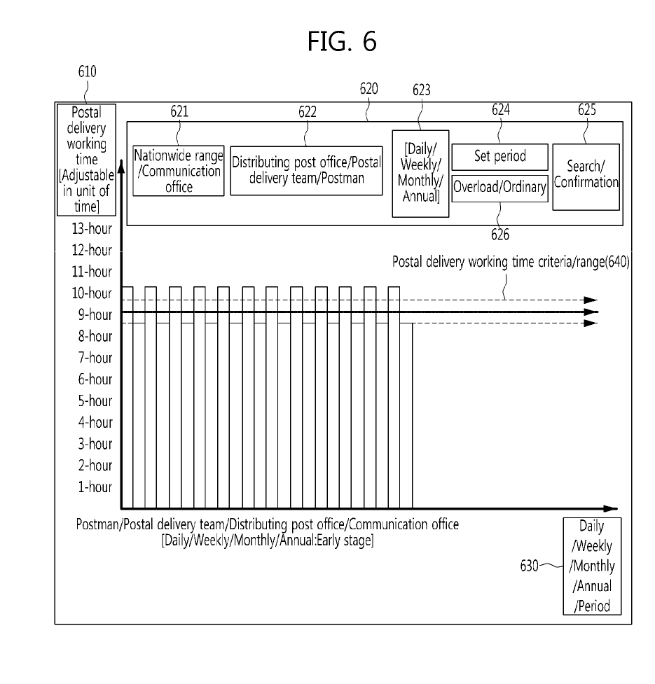

FIG. 6 shows a graph display screen for displaying a postal delivery operation load provided by the postal delivery operation load management system in accordance with an exemplary embodiment of the present invention.

Referring to FIG. 6, a vertical axis 610 of the postal delivery operation load graph represents a postal delivery working time in units of time. A horizontal axis 630 represents a date and a period such as a day, a month, etc. Here, the time unit of the vertical axis 610 can be adjusted by a user. Also, the postal delivery operation load graph includes a display item selection area 620 and a section 640 for displaying the criteria and range of the postal delivery working time. The display item selection area 620 allows a user to select one of the nationwide range, the communication office, the distributing post office, the postal delivery team, and the postman or to select a date with respect to the calculated postal delivery operation load.

The display item selection area 620 may include a section 621 for selecting the nationwide range or the communication office, a section 622 for selecting one of the distributing post office, the postal delivery team, and the postman, a section 623 for selecting one of the daily, weekly, monthly, and annual amounts of the postal delivery operation load, a section 624 for setting a period, a section 625 for search and confirmation, and a section 626 for selecting the postal delivery operation overload and a general (average) postal delivery operation load.

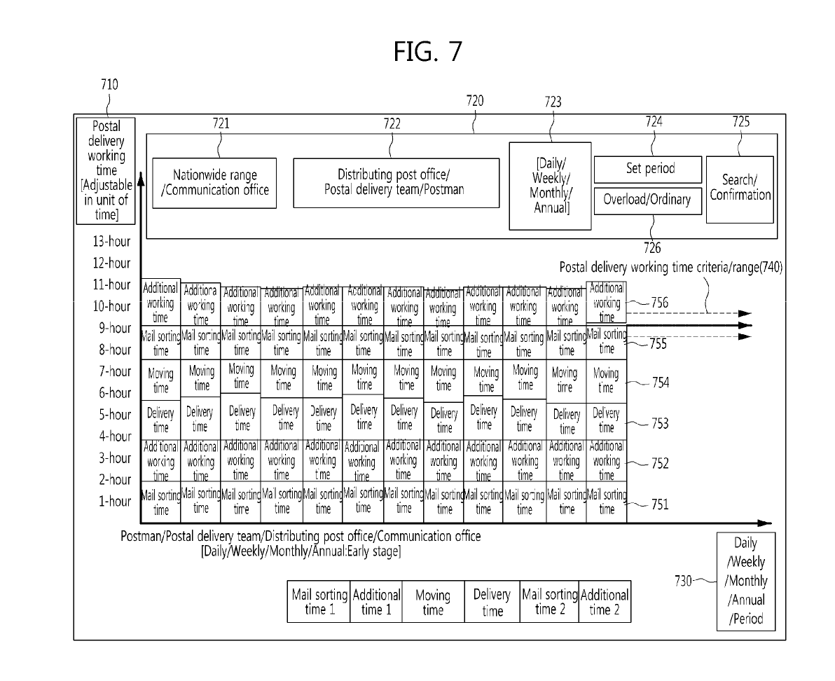

FIG. 7 shows a graph display screen for displaying detailed components of the postal delivery operation load provided by the postal delivery operation load management system in accordance with an exemplary embodiment of the present invention.

Referring to FIG. 7, a vertical axis 710 of the graph showing detailed components of the postal delivery operation load represents a postal delivery working time in units of time. A horizontal axis 730 represents a date and a period such as a day, a month, etc. Here, the time unit of the vertical axis 710 can be adjusted by a user. Also, the graph showing the detailed components of the postal delivery operation load includes a display item selection area 720 and a section 740 for displaying the criteria and range of the postal delivery working time. The display item selection area 720 allows a user to select one of the nationwide range, the communication office, the distributing post office, the postal delivery team, and the postman or to select a date with respect to the calculated postal delivery operation load.

The graph showing the detailed components of the postal delivery operation load may include the detailed components of the calculated postal delivery working time, such as a first indoor mail sorting time 751, a first indoor additional working time 752, a delivery time 753, a moving time 754, a second mail sorting time 755 and a second additional working time 756.

The display item selection area 720 may include a section 721 for selecting the nationwide range or the communication office, a section 722 for selecting one of the distributing post office, the postal delivery team and the postman, a section 723 for selecting one of the daily, weekly, monthly, and annual amounts of the postal delivery operation load, a section 724 for setting a period, a section 725 for search and confirmation, and a section 726 for selecting the postal delivery operation overload and a general (average) postal delivery operation load.

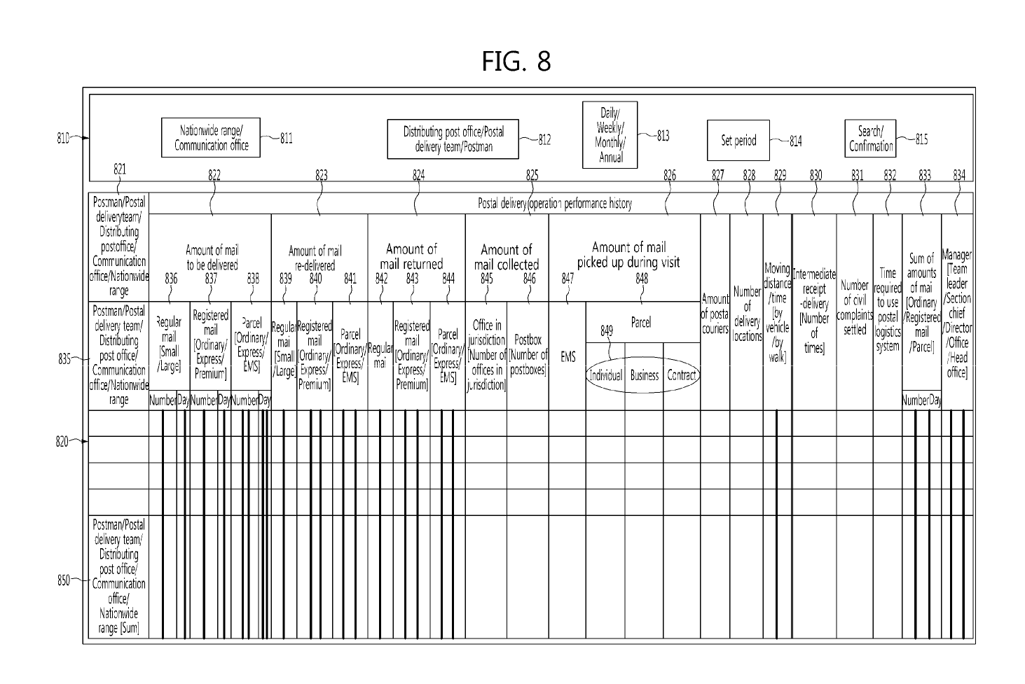

FIG. 8 shows a display screen for verifying postal delivery operation performance history and input data provided by the postal delivery operation load management system in accordance with an exemplary embodiment of the present invention.

Referring to FIG. 8, the display screen for verifying the postal delivery operation performance history and input data includes a display item selection area 810 and a display area 820 for displaying the verification of the postal delivery operation performance history and input data. The display item selection area 810 allows a user to select one of the nationwide range, the communication office, the distributing post office, the postal delivery team, and the postman or to select a date with respect to the postal delivery operation performance history and input data.

The display item selection area 810 may include a section 811 for selecting the nationwide range or the communication office, a section 812 for selecting one of the distributing post office, the postal delivery team and the postman, a section 813 for selecting one of the daily, weekly, monthly, and annual amounts of the postal delivery operation load, a section 814 for setting a period, and a section 815 for search and confirmation.

The display area 820 for displaying the verification of the postal delivery operation performance history and input data include a section 821 for selecting one of the postman, the postal delivery team, the distributing post office, the communication office, and the nationwide range, a section 822 for displaying the amount of mail delivered, a section 823 for displaying the amount of mail re-delivered, a section 824 for displaying the amount of mail returned, a section 825 for displaying the amount of mail collected, a section 826 for displaying the amount of mail picked up during a visit, a section 827 for displaying the amount of postal couriers, a section 828 for displaying the number of delivery locations, a section 829 for displaying a vehicle travel distance and a walking distance, a section 830 for displaying an intermediate receipt-delivery process history, a section 831 for displaying the number of civil complaints settled, a section 832 for displaying the amount of time required to use a postal logistics system, a section 833 for displaying a sum of the amounts of mail for each mail type, a display section 834 for confirmation and verification of daily, weekly, monthly, annual and date-based postal delivery operation performance histories and input data by a postal delivery team leader, a section chief, a director of a postal distribution department, and a postal delivery representative of a communication office and head office.

The section 822 for displaying the amount of mail delivered may include a section 836 for displaying the amount of large and small regular mail, a section 837 for displaying the amount of registered mail such as registered mail, express mail, contract registered mail, etc., and a section 838 for displaying the amount of parcels such as parcels, express parcels, international express mail (EMS), etc.

The section 823 for displaying the amount of mail re-delivered may include sections for displaying the amount of regular mail 839, the amount of registered mail 840, and the amount of parcels 840. The section 824 for displaying the amount of mail returned may include sections for displaying the amount of regular mail 842, the amount of registered mail 843, and the amount of parcels 844. The section 825 for displaying the amount of mail collected may include a section 845 of the amount of mail collected within a jurisdiction and a section 846 of the amount of mail collected from postboxes.

The section 826 for displaying the amount of mail picked up during a visit may include sections for displaying EMS 847 and parcels 848. The parcels picked up during a visit may include individual, business and contract sections 849.

With respect to the item selected from the postman, the postal delivery team, the distributing post office, the communication office, and the nationwide range, the display area 820 for displaying the verification of the postal delivery operation performance history and input data may include a section 850 for displaying a postal delivery operation performance history for each period and for each date and a total sum of the input data.

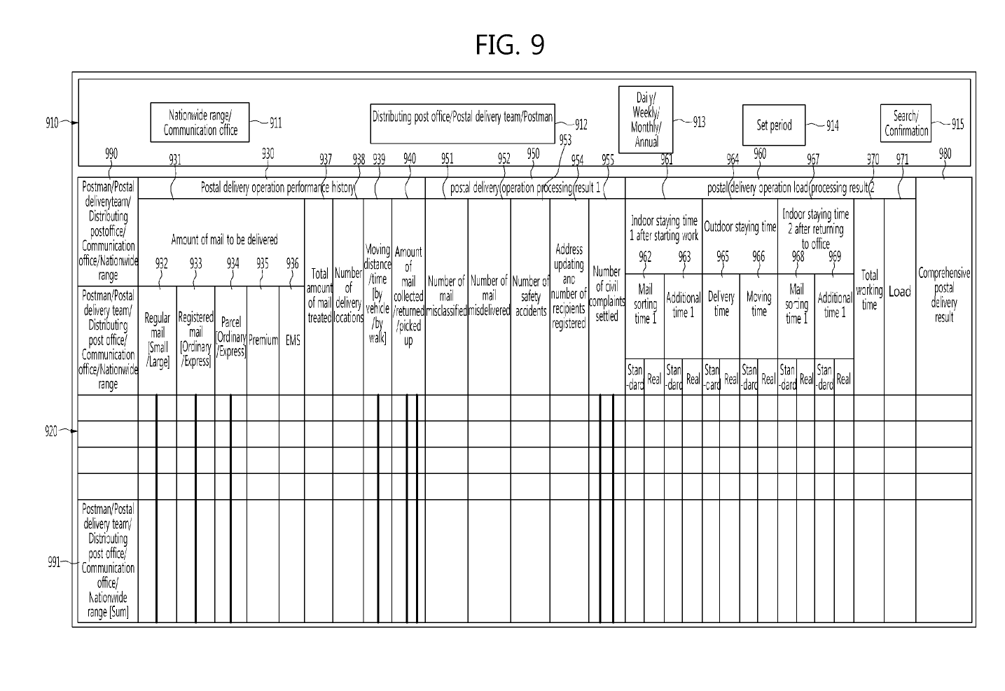

FIG. 9 shows a display screen for displaying a postal delivery operation result provided by the postal delivery operation load management system in accordance with an exemplary embodiment of the present invention.

Referring to FIG. 9, the display screen for displaying the postal delivery operation result includes a display item selection area 910 and a display area 920. The display item selection area 910 allows a user to select one of the nationwide range, the communication office, the distributing post office, the postal delivery team, and the postman or to select a date with respect to the postal delivery operation result. The display area 920 displays the selected postal delivery operation result.

The display item selection area 910 may include a section 911 for selecting the nationwide range or the communication office, a section 912 for selecting one of the distributing post office, the postal delivery team and the postman, a section 913 for selecting one of the daily, weekly, monthly, and annual amounts of the postal delivery operation load, a section 914 for setting a period, and a section 915 for search and confirmation.

The display area 920 for displaying the selected postal delivery operation result may include a section 990 for selecting one of the postman, the postal delivery team, the distributing post office, the communication office, and the nationwide range, a section 930 for displaying the postal delivery operation performance history, a first section 950 for displaying the postal delivery processing result, a second section 960 for displaying the postal delivery processing result, and a section 980 for displaying a comprehensive postal delivery result.

The section 930 for displaying the postal delivery operation performance history may include a section 931 for displaying the amount of mail delivered, a section 937 for displaying the total amount of mail treated, a section 938 for displaying the number of delivery locations, a section 939 for displaying a vehicle travel distance and a walking distance, and a section 940 for displaying the amount of mail collected, returned, and picked up.

The section 931 for displaying the amount of mail delivered may include a section 932 for displaying the amount of large and small regular mail, a section 933 for displaying the amount of registered mail such as registered mail and express mail, a section 934 for displaying the amount of parcels such as parcels and express parcels, a section 935 for displaying the amount of contract registered mail, and a section 936 for displaying the amount of EMS.

The first section 950 for displaying the postal delivery processing result may include a section 951 for displaying the number of mail misclassified, a section 952 for displaying the number of mail misdelivered, a section 953 for displaying the number of safety accidents, a section 954 for displaying an address updating process and the number of recipients registered, and a section 955 for displaying the number of civil complaints settled.

The second section 960 for displaying the postal delivery processing result may include a section 961 for displaying an indoor staying time after starting work, a section 964 for displaying an outdoor staying time after starting work, a section 967 for displaying an indoor staying time after returning to the office, a section 970 for displaying a total working time, and a section 971 for displaying the postal delivery operation load.

The section 961 for displaying the indoor staying time after starting work may include a section 962 for displaying a mail sorting time for separating and combining the mail routes with respect to registered mail or parcels to be delivered on a day, a section for displaying an actual elapsed time and a statistical reference value for the mail sorting time, a section 963 for displaying an additional time required to use a system for processing the postal delivery operation to be performed and registering the amount of mail to be delivered before departing from the office, and a section for displaying an actual elapsed time and a statistical reference value for the additional time.

The section 964 for displaying the outdoor staying time after starting work may include a section 965 for displaying an elapsed time for the mail delivery on a day, a section for displaying an actual elapsed time and a statistical reference value for the elapsed time, a section 966 for displaying a moving time for the mail delivery, and a section for displaying an actual elapsed time and a statistical reference value for the moving time.

The section 967 for displaying an indoor staying time after returning to the office may include a section 968 for displaying a mail sorting time for separating and combining the mail routes with respect to regular mail to be delivered on the next day, a section for displaying an actual elapsed time and a statistical reference value for the mail sorting time, a section 969 for displaying an additional time required to use a system for processing the postal delivery operation performed and registering the amount of mail delivered after returning to the office, and a section for displaying an actual elapsed time and a statistical reference value for the additional time.

With respect to the item selected from the postman, the postal delivery team, the distributing post office, the communication office, and the nationwide range, the display area 920 for displaying the selected postal delivery operation result may include a section 991 for displaying a total sum of postal delivery operation results for each period and for each date.

As described above, according to the system and method for managing the postal delivery operation load of the present invention, the postal delivery operation load is calculated based on the amount of mail to be delivered, the number of delivery locations, and a statistical reference value for each mail type and for each delivery condition calculated with respect to each detailed postal delivery operation without using a reference value for each type of the distributing post offices classified, and various management interface screens for managing the postal delivery operation are provided.

As a result, it is possible to objectively measure and evaluate the postal delivery operation load and thus to adjust and level the postal delivery operation based on the postal delivery operation load, thereby efficiently managing the human resources required for the postal delivery operation.

Moreover, the system and method for managing the postal delivery operation load in accordance with the exemplary embodiments of the present invention can be applied to the courier operation environment to measure and adjust the courier operation load.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A system for managing a postal delivery operation load, the system comprising:
a postal delivery operation load calculator for calculating a postal delivery operation load for each postal delivery unit and for each period based on input postal delivery data;
a postal delivery operation load calculation result manager for managing the postal delivery operation load for each postal delivery unit based on the postal delivery operation load calculation result provided by the postal delivery operation load calculator; and
a postal delivery operation load adjuster for adjusting and leveling the postal delivery operation based on postal delivery operation load management information provided by the postal delivery operation load calculation result manager.

2. The system of claim 1, wherein the postal delivery operation load calculator calculates a daily postal delivery operation load for each postman based on at least one of a daily mail sorting time, a moving time, a delivery time, and an additional working time for each postman and calculates at least one of weekly, monthly, quarterly, and annual postal delivery operation loads for each postman based on the calculated daily postal delivery operation load for each postman.

3. The system of claim 2, wherein the postal delivery operation load calculator calculates a daily postal delivery operation load for each postal delivery team based on the calculated daily postal delivery operation load for each postman and calculates at least one of weekly, monthly, quarterly, and annual postal delivery operation loads for each postal delivery team based on the calculated daily postal delivery operation load for each postal delivery team.

4. The system of claim 3, wherein the postal delivery operation load calculator calculates a daily postal delivery operation load for each distributing post office based on the calculated daily postal delivery operation load for each postal delivery team and calculates at least one of weekly, monthly, quarterly, and annual postal delivery operation loads for each distributing post office based on the calculated daily postal delivery operation load for each distributing post office.

5. The system of claim 2, wherein the postal delivery operation load calculator calculates a postal delivery operation value by summing all the daily mail sorting time, the moving time, the delivery time, and the additional working time for each postman, calculates a total postal delivery operation by adding a predetermined margin value to the calculated postal delivery operation value, and then calculates the daily postal delivery operation load for each postman by dividing the total postal delivery operation by a daily standard working time.

6. The system of claim 2, wherein the mail sorting time is calculated based on the amount of mail and a standard processing time per mail for each mail type and for each delivery condition, the moving time is calculated based on a moving distance and a standard moving time per kilometer for each delivery condition, the delivery time is calculated based on the amount of mail and a standard processing time per mail for each mail type and for each delivery condition, the number of delivery locations for each mail type and for each delivery condition, and a standard processing time per delivery location, and the additional working time is calculated based on the amount of mail returned and collected, a standard processing time per mail, and a time for a fixed work.

7. The system of claim 1, further comprising:
a data linker for collecting information on the amount of mail to be delivered, which is distributed and delivered to each distributing post office by a postal central office;
a data inputter for receiving data input for the purpose of calculating the postal delivery operation load or data relating to the postal delivery operation input through a postal management terminal; and
an input data verifier for verifying the accuracy of the data provided from the data linker and the data inputter and providing the verified data to the postal delivery operation load calculator.

8. The system of claim 1, further comprising:
a postal delivery operation load parameter adjuster for adjusting postal delivery operation load calculation factors or models and providing the adjusted results to the postal delivery operation load calculator;
a postal delivery operation load calculation result verifier for statistically analyzing and verifying the postal delivery operation load calculation result calculated for each postal delivery unit and for each period and provided by the postal delivery operation load calculator;
a postal delivery database for storing data required for the postal delivery operation; and
a postal delivery database linker for linking the postal delivery database to the postal delivery operation load calculator for the purpose of calculating the postal delivery operation load.

9. The system of claim 1, further comprising:
a postal delivery operation result manager for analyzing and managing a postal delivery operation result based on the postal delivery operation load calculation result provided by the postal delivery operation load calculator and a postal delivery operation load adjustment result provided by the postal delivery operation load adjuster; and
a postal delivery operation load monitor for monitoring, in real time, the calculated postal delivery operation load.

10. A method for managing a postal delivery operation load, the method comprising:
obtaining data for calculating a postal delivery operation load;
calculating factors for calculating the postal delivery operation load based on the obtained data for calculating the postal delivery operation load; and
calculating the postal delivery operation load based on the factors for calculating the postal delivery operation load.

11. The method of claim 10, wherein the obtaining the data for calculating the postal delivery operation load comprises obtaining at least one of information on the amount of mail returned and collected, information on a time for a fixed work, information on a moving distance for each delivery condition, information on the amount of mail for each mail type and for each delivery condition, and information on the number of delivery locations for each mail type and for each delivery condition.

12. The method of claim 10, wherein the calculating the factors for calculating the postal delivery operation load comprises:
calculating an additional working time based on the amount of mail returned and collected, a standard processing time per mail, and a time for a fixed work;
calculating a moving time based on a moving distance and a standard moving time per kilometer for each delivery condition;
calculating a mail sorting time based on the amount of mail and a mail sorting time per mail for each mail type and for each delivery condition; and
calculating a delivery time based on the amount of mail and a mail sorting time per mail for each mail type and for each delivery condition, the number of delivery locations for each mail type and for each delivery condition, and a standard processing time per delivery location.

13. The method of claim 12, wherein the calculating the postal delivery operation load further comprises:
calculating a postal delivery operation value by summing all the mail sorting time, the moving time, the delivery time, and the additional working time, calculating a total postal delivery operation by adding a predetermined margin value to the calculated postal delivery operation value, and then calculating a daily postal delivery operation load for each postman by dividing the total postal delivery operation by a daily standard working time; and
calculating at least one of weekly, monthly, quarterly, and annual postal delivery operation loads for each postman based on the calculated daily postal delivery operation load for each postman.

14. The method of claim 13, wherein the calculating the postal delivery operation load further comprises:
calculating a daily postal delivery operation load for each postal delivery team based on the calculated daily postal delivery operation load for each postman;
calculating at least one of weekly, monthly, quarterly, and annual postal delivery operation loads for each postal delivery team based on the calculated daily postal delivery operation load for each postal delivery team.

15. The method of claim 14, wherein the calculating the postal delivery operation load further comprises:
calculating a daily postal delivery operation load for each distributing post office based on the calculated daily postal delivery operation load for each postal delivery team; and
calculating at least one of weekly, monthly, quarterly, and annual postal delivery operation loads for each distributing post office based on the calculated daily postal delivery operation load for each distributing post office.
